(19) United States
(12) Patent Application Publication
(10) Pub. No.: US 2012/0151089 A1
(43) Pub. Date: Jun. 14, 2012

(54) DIRECT DATA COMMUNICATION IN A PEER-TO-PEER NETWORK

(75) Inventors: Kayalvizhi Ponmudi, Chennai (IN); Karthickraja Chandrasekar, Chennai (IN)

(73) Assignee: Atheros Communications, Inc., San Jose, CA (US)

(21) Appl. No.: 12/963,160

(22) Filed: Dec. 8, 2010

(51) Int. Cl. G06F 15/16

(52) U.S. Cl. 709/237

(57) ABSTRACT

A direct data communication link can be established for direct data communication between a first network device and a second network device of a peer-to-peer network. On determining to communicate with the second network device, the first network device can determine, based on a beacon message broadcast by a managing network device of the peer-to-peer network, whether the second network device supports a direct data communication protocol. If it is determined that both the first network device and the second network device support the direct data communication protocol, a set of handshake messages associated with the direct data communication protocol can be exchanged to establish the direct data communication link between the first network device and the second network device. Subsequent data messages can be exchanged between the first network device and the second network device via the direct data communication link.

### BACKGROUND

Embodiments of the inventive subject matter generally relate to the field of communication systems and, more particularly, to direct data communication in a peer-to-peer network.

Clients in a peer-to-peer (P2P) communication network typically connect to a managing entity of the P2P communication network (also known as a group owner). The group owner can govern communications between the clients of the P2P communication network. In other words, the clients of the P2P communication network can communicate with other clients of the P2P communication network via the group owner. Also, when a new client connects to the P2P communication network (and consequently to the group owner) and/or when clients acquire new communication capabilities, the group owner can advertise the new client and/or the new communication capabilities to other clients in the P2P communication network.

### SUMMARY

Various embodiments for direct data communication in a peer-to-peer network are disclosed. In one embodiment, a first network device of a peer-to-peer communication network determines to communicate with a second network device of the peer-to-peer communication network. It is determined, at the first network device, whether the second network device supports a direct data communication protocol supported at the first network device based on an indication received from a managing network device of the peer-to-peer communication network. In response to determining that the second network device supports the direct data communication protocol, a set of handshake messages associated with the direct data communication protocol are exchanged with the second network device to establish a direct data communication link between the first network device and the second network device. Subsequent data messages are transmitted from the first network device to the second network device via the direct data communication link.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram illustrating operations for direct data communication in a peer-to-peer network;

FIG. 2 is a flow diagram illustrating example operations for implementing direct data communication in a peer-to-peer network;

FIG. 3 is a continuation of FIG. 2 and depicts the flow diagram illustrating example operations for implementing direct data communication in the peer-to-peer network; and

FIG. 4 is a block diagram of one embodiment of an electronic device including a mechanism for direct data communication in a peer-to-peer network.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to enabling direct data communication between wireless local area network (WLAN) devices, embodiments are not so limited. In other implementations, techniques for direct data communication as described herein can be executed between devices that implement other suitable communication standards and technologies (e.g., WiMAX). In other instances, well-known instruction instances, protocols, structures, and techniques have not been shown in detail in order not to obfuscate the description.

Clients in a P2P communication network (“P2P clients”) typically communicate with each other via a managing network device also known as a group owner (P2PGO). The P2PGO periodically broadcasts a beacon message (e.g., comprising a P2P information element (IE)) to advertise the P2P clients, the communication capabilities of the P2P clients, etc. To enable communication between the P2P clients, the P2PGO can receive communications from an initiating P2P client and can forward the received communications to a destination P2P client. However, communicating via the P2PGO can decrease the throughput of the P2P communication network and can increase the overhead associated with the P2PGO. Furthermore, to enable communication between the P2P clients, the P2PGO is typically required to have the same communication capabilities as the initiating P2P client and the destination P2P client. For example, if the initiating P2P client and the destination P2P client support 802.11n data rates (i.e., high data rates) but the P2PGO is a legacy device that supports a slower legacy data rate, the initiating P2P client and the destination P2P client may exchange data messages using only the slower legacy data rate. In other words, communication between the P2P clients can be limited by the communication capabilities of the P2PGO.

In some embodiments, P2P clients can be configured for direct data communication using a Tunneled Direct link setup (TDLS) protocol. The initiating P2P client can establish a TDLS communication link with the destination P2P client to facilitate direct data communication between the P2P clients without intervention by the P2PGO. In some implementations, the P2PGO can be configured to broadcast beacon messages (e.g., including the P2P IE) that indicate whether/which P2P clients support the TDLS protocol. The P2PGO can utilize the beacon messages to advertise the new P2P clients, the communication capabilities of the P2P clients, whether the P2P clients support the TDLS protocol, etc. On determining to communicate with the destination P2P client, the initiating P2P client can, based on TDLS support information in the beacon message from the P2PGO, determine whether the destination P2P client supports the TDLS protocol. On determining that the initiating P2P client and the destination P2P client support the same communication capabilities, the initiating P2P client and the destination P2P client can exchange TDLS handshake messages to establish the TDLS communication link. If a secure TDLS communication link is to be established, handshake messages for deriving a session key (e.g., TDLS peer key (TPK) handshake messages) can be embedded into the TDLS handshake messages. After the TDLS communication link is established, the initiating P2P client and the destination P2P client can directly communicate with each other. The direct data communication mechanism can increase the throughput of the P2P communication network and can reduce the overhead on the P2PGO. Furthermore, the P2PGO need not have the same communication capabilities as the initiating P2P client and the destination P2P client. For example, the P2PGO need not support the same data rates as the initiating P2P client and the destination P2P client and may not even support the TDLS protocol. In other words, the communication between the initiating P2P client and the destination P2P client may not be limited by the communication capabilities of the P2PGO.

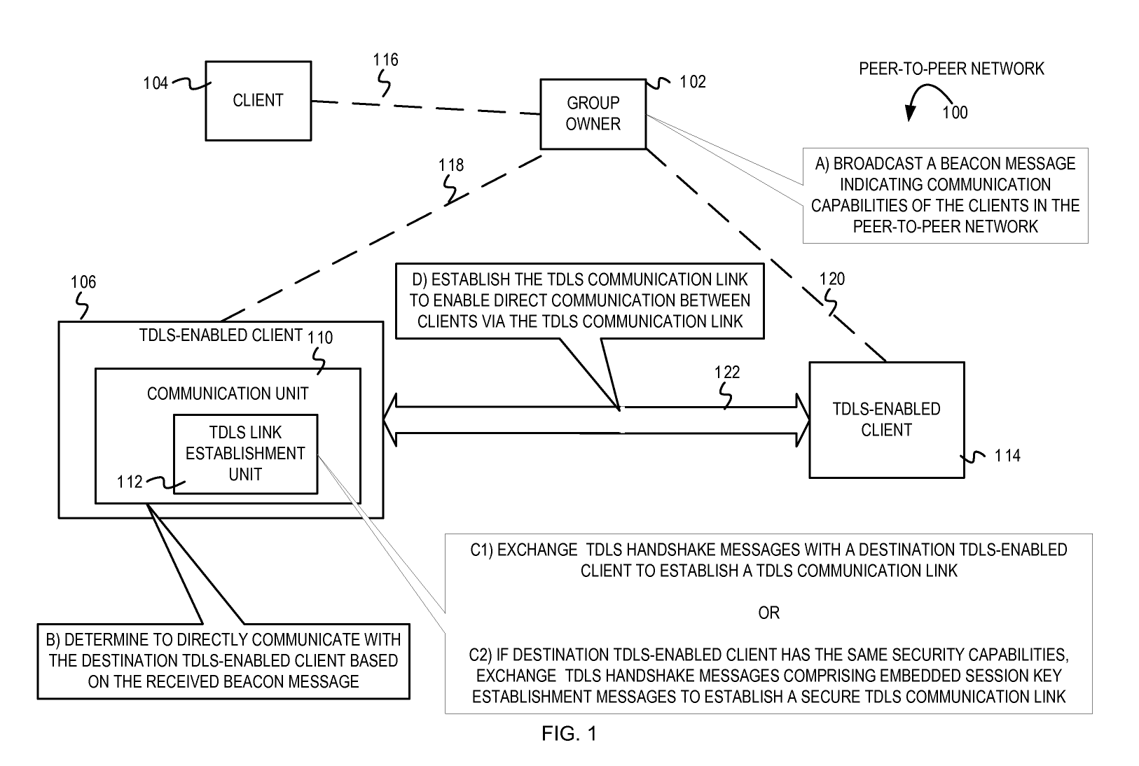

FIG. 1 is an example conceptual diagram illustrating operations for direct data communication in a peer-to-peer network 100. The peer-to-peer network 100 comprises a peer-to-peer network group owner (P2PGO or group owner) 102 and P2P clients 104, 106, and 114. The clients 104, 106, and 114 are connected to the group owner 102 as depicted by dashed connecting lines 116, 118, and 120 respectively. In FIG. 1, the clients 106 and 114 support a TDLS protocol and are herein referred to as “TDLS-enabled clients”. Each TDLS enabled client 106 comprises a communication unit 110. The communication unit 110 comprises a TDLS link establishment unit 112. The client 104 is not a TDLS-enabled client, and although not depicted in FIG. 1, the client 104 could also comprise a communication unit.

The group owner 102 typically operates as a bridge between two or more clients 104, 106, and 114 and/or between the clients 104, 106, and 114 and an external communication network. For example, the group owner 102 can enable the clients 104, 106, and 114 to connect to the Internet or to an external infrastructure network. In one example, the group owner 102 may be a dedicated device that manages communication between the clients 104, 106, and 114 in the peer-to-peer network 100. In another example, the group owner 102 can be any suitable electronic device that enables the clients 104, 106, and 114 (e.g., laptops, mobile phones or other suitable electronic devices) to join the peer-to-peer network 100 and manages communication between the clients 104, 106, and 114. In one implementation, the clients 104, 106, and 114 can be wireless local area network (WLAN) clients that communicate with each other and with the group owner 102 using 802.11a/b/g/n communication protocols. In another implementation, the group owner 102 and the clients 104, 106, and 114 can communicate in accordance with other suitable communication protocols. The TDLS-enabled clients can execute operations, that will be described below in stages A-D, to establish a TDLS communication link and to directly communicate (e.g., without intervention of the group owner 102) with other TDLS-enabled clients of the peer-to-peer network 100.

At stage A, the group owner 102 broadcasts a beacon message indicating, at least, communication capabilities supported by the clients 104, 106, and 114 of the peer-to-peer network 100. The beacon message can identify clients in the peer-to-peer network 100, indicates communication capabilities of the clients 104, 106, and 114, etc. The beacon message can also indicate whether each of the clients 104, 106, and 114 in the peer-to-peer network support the TDLS protocol. As described herein, the TDLS protocol can enable a TDLS-enabled client to establish a direct communication link (and consequently communicate without intervention from the group owner 102) with another TDLS-enabled client of the peer-to-peer network. In one implementation, the beacon message can include a P2P information element that comprises a TDLS flag (e.g., one or more bits) for each client of the peer-to-peer network 100. The group owner 102 can assign a predetermined value to the TDLS flag depending on whether the client associated with the TDLS flag supports the TDLS protocol. For example, the group owner 102 may assign a first predetermined value to the TDLS flag associated with the client 106 to indicate that the client 106 supports the TDLS protocol (and is a TDLS-enabled client). As another example, the group owner 102 may assign a second predetermined value to the TDLS flag associated with the client 104 to indicate that the client 104 does not support the TDLS protocol (and is not a TDLS-enabled client). The clients 104, 106, and 114 can each receive the beacon message broadcast from the group owner 102 and can store indications of the communication capabilities of the other clients in the peer-to-peer network 100.

At stage B, an initiating TDLS-enabled client 106 determines to communicate with the destination client 114. The initiating TDLS-enabled client 106 can, based on the beacon message broadcast by the group owner 102, determine whether the destination client 114 is a TDLS-enabled client. For example, the TDLS link establishment unit 112 can read the TDLS flag associated with the destination client 114 from the beacon message to determine whether the destination client 114 supports the TDLS protocol 114. In FIG. 1, the TDLS link establishment unit 112 determines that the destination client 114 is a TDLS-enabled client. Based on the beacon message received from the group owner 102, the TDLS link establishment unit 112 of the initiating TDLS-enabled client 106 can also ascertain the communication capabilities of the destination TDLS-enabled client 114. For example, the TDLS link establishment unit 112 may determine one or more data rates supported by the destination TDLS-enabled client 114, one or more modulation schemes supported by the destination TDLS-enabled client 114, an identifier of the destination TDLS-enabled client 114, one or more encryption standards supported by the destination TDLS-enabled client 114, etc.

On determining that the initiating client 106 and the destination client 114 both support the TDLS protocol and other communication capabilities (e.g., modulation schemes, data rates, etc.), the TDLS link establishment unit 112 can determine to establish a TDLS communication link for direct communication with the destination TDLS-enabled client 114. For example, it may be determined that the destination TDLS-enabled client 114 supports the TDLS protocol, is connected to the same group owner 102, and supports at least one data rate, at least one modulation scheme, and at least one encryption standard as supported by the initiating TDLS-enabled client 106. Accordingly, the TDLS link establishment unit 112 can determine to establish the TDLS communication link with the destination TDLS-enabled client 114. The initiating TDLS-enabled client 106 and the destination TDLS-enabled client 114 can then initiate TDLS handshake operations to establish a non-secure TDLS communication link (described in stage C1) or a secure TDLS communication link (described in stage C2).

At stage C1, the TDLS link establishment unit 112 exchanges TDLS handshake messages with the destination TDLS-enabled client 114 to establish the TDLS communication link 122 between the initiating TDLS-enabled client 106 and the destination TDLS-enabled client 114. In one implementation, the TDLS communication link 122 can be established by a 3-way TDLS handshake procedure. As part of the 3-way TDLS handshake procedure, the initiating TDLS-enabled client 106 can transmit a TDLS request message to the destination TDLS-enabled client. The destination TDLS-enabled client 114, in turn, can transmit a TDLS response message to the initiating TDLS-enabled client 106. Finally, the initiating TDLS-enabled client 106 can transmit a TDLS confirmation message to the destination TDLS-enabled client 114. The TDLS request message, the TDLS response message, and the TDLS confirmation message can each comprise a link identifier, an indication of supported security protocols, timing information, etc. The TDLS communication link 122 between the initiating TDLS-enabled client 106 and the destination TDLS-enabled client 114 may be deemed to be established after the destination TDLS-enabled client 114 receives the TDLS confirmation message.

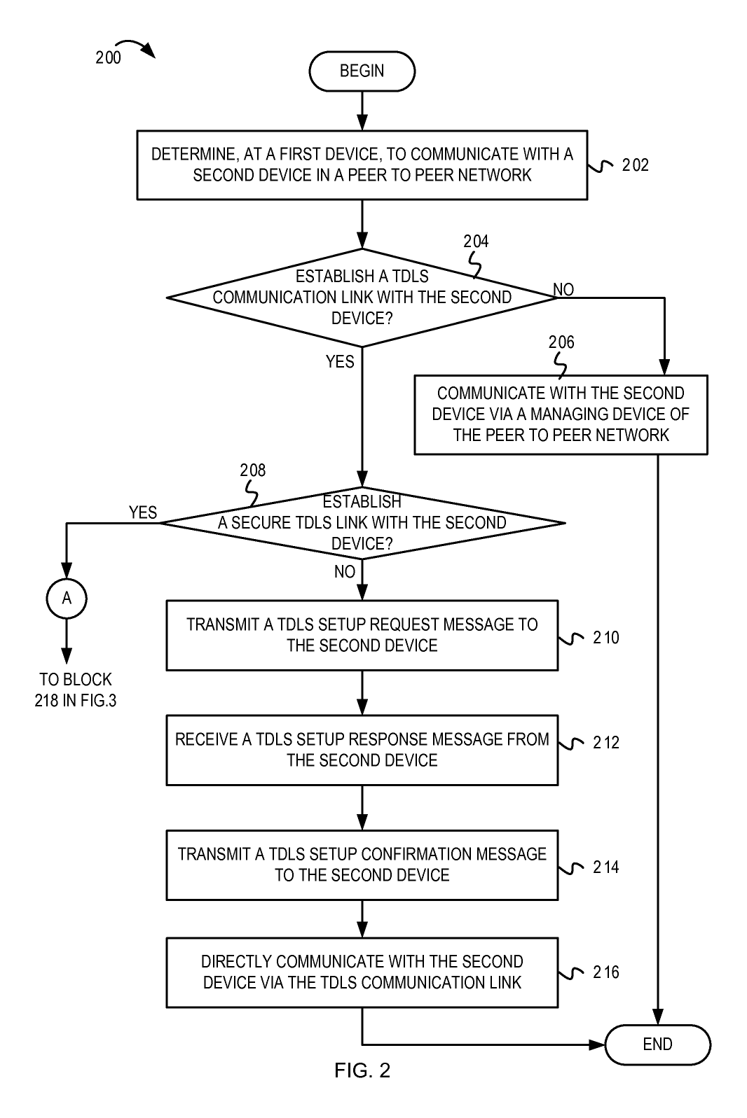

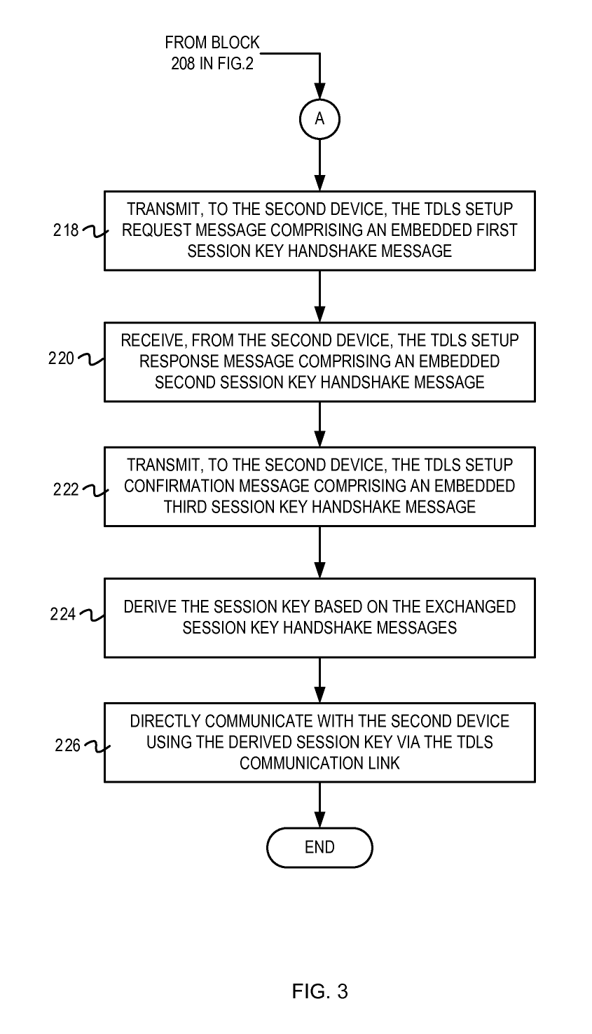

At stage C2, the TDLS link establishment unit 112 exchanges the TDLS handshake messages comprising embedded session key establishment messages with the destination TDLS-enabled client 114 to establish a secure TDLS communication link. In one implementation, the TDLS link establishment unit 112 can determine (e.g., from the beacon message broadcast by the group owner 102) security protocols supported at the destination TDLS-enabled client 114. In another implementation, the TDLS link establishment unit 112 can indicate security protocols supported at the initiating TDLS-enabled client 106 and can request information regarding security protocols supported at the destination TDLS-enabled client 114. The secure TDLS communication link can be established if the initiating TDLS-enabled client 106 and the destination TDLS-enabled client 114 support the same security protocols. In another implementation, the TDLS link establishment unit 112 can determine whether the initiating TDLS-enabled client 106 and the destination TDLS-enabled client 114 are securely connected (e.g., using a Wi-Fi Protected Access version 2 using a pre-shared key (WPA2/PSK) security protocol) to the group owner 102, prior to initiating the 3-way TDLS handshake procedure. If the TDLS link establishment unit 112 determines that the initiating TDLS-enabled client 106 and the destination TDLS-enabled client 114 support the same security protocols, the TDLS link establishment unit 112 can attempt to establish a secure TDLS communication link with the destination TDLS-enabled client 114. In one example, the initiating TDLS-enabled client 106 can initiate a 3-way TDLS Peer Key (TPK) handshake procedure with the destination TDLS-enabled client 114 to determine the TPK. TPK handshake messages can be embedded within the TDLS handshake messages so that a single set of handshake messages can be used to generate the TDLS communication link and to derive the TPK. As will be further described below in FIGS. 2-3, a first TPK handshake message can be embedded into the TDLS request message, a second TPK handshake message can be embedded into the TDLS response message, and a third TPK handshake message can be embedded into the TDLS confirmation message.

It is noted that if the initiating TDLS-enabled client 106 and the destination TDLS-enabled client 114 do not support the same security protocols and/or if either of the TDLS-enabled clients 106 and 114 have not established a secure link with the group owner 102, only the TDLS handshake messages can be exchanged (without the embedded TPK handshake messages) to establish the TDLS communication link, as described with reference to stage C1.

At stage D, the TDLS link establishment unit 112 establishes the TDLS communication link 122 with the destination TDLS-enabled client 114 to enable direct data communication via the TDLS communication link 122. For example, a laptop (i.e., the initiating TDLS-enabled client 106) may establish the TDLS communication link 122 with a printer (i.e., the destination TDLS-enabled client 114) and may directly transmit content to the printer via the TDLS communication link 122. As another example, a WLAN-based digital camera (i.e., the initiating TDLS-enabled client 106) may establish the communication link TDLS 122 with a laptop (i.e., the destination TDLS-enabled client 114) and may directly transmit digital photographs to the laptop via the TDLS communication link 122. If a session key (e.g., the TPK) was derived as part of establishing the TDLS communication link (as described with reference to stage C2), the initiating TDLS-enabled client 106 and the destination TDLS-enabled client 114 can encrypt (and subsequently decrypt) messages exchanged via the TDLS communication link 122.

FIG. 2 and FIG. 3 depict a flow diagram (“flow”) 200 illustrating example operations for implementing direct data communication in a peer-to-peer network. The flow 200 begins at block 202.

At block 202, a first device of a peer-to-peer network determines to communicate with a second device of the peer-to-peer network. For example, with reference to FIG. 1, the TDLS-enabled client 106 of the peer-to-peer network 100 can determine to communicate with the TDLS-enabled client 114. The flow continues at block 204.

At block 204, it is determined whether a TDLS communication link should be established with the second device. For example, the TDLS link establishment unit 112 of the TDLS-enabled client 106 can determine whether the TDLS communication link should be established with the destination client 114. As described above, a managing device (e.g., the group owner 102) of a peer-to-peer network 100 can broadcast a beacon message that identifies clients that are a part of the peer-to-peer network 110, communication capabilities of the clients, whether the clients support the TDLS protocol, etc. The TDLS link establishment unit 112 can read the beacon message and can determine whether the destination client 114 belongs to the same basic service set (i.e., is connected to the same group owner 102) as the initiating TDLS-enabled client 104. If so, the TDLS link establishment unit 112 can read a TDLS flag associated with the destination client 114 from the beacon message and can determine whether the destination client 114 is also a TDLS-enabled client. In some implementations, the TDLS link establishment unit 112 can also determine, from the beacon message broadcast by the group owner 102, communication capabilities (e.g., data rates, modulation schemes, etc.) of the second device. Based on the beacon message received from the group owner 102, the TDLS link establishment unit 112 can ascertain whether the TDLS communication link can be established with the second device. If it is determined that the TDLS communication link should be established with the second device, the flow continues at block 208. Otherwise, the flow continues at block 206.

At block 206, the first device communicates with the second device via the managing device of the peer-to-peer network. For example, on determining that the second device does not support the TDLS protocol, that the second device does not support TDLS link establishment procedures, and/or that the second device does not support the same communication capabilities (e.g., data rate, modulation scheme, etc.) as the first device, the first device determines that the TDLS communication link cannot be established with the second device. Consequently, the first device can communicate with the second device via the group owner 102. The first device can transmit messages to the group owner 102 and can identify the second device. The group owner 102, in turn, can transmit the message to the second device. From block 206, the flow ends.

At block 208, it is determined whether a secure TDLS communication link should be established with the second device. The flow 200 moves from block 204 to block 208 on determining that the second device does supports the TDLS protocol and that the TDLS communication link should be established with the second device. With reference to FIG. 1, the TDLS link establishment unit 112 of the initiating TDLS-enabled client 106 (i.e., the first device) determines whether to establish a secure TDLS communication link with the destination TDLS-enabled client 114 (i.e., the second device). In one implementation, the TDLS link establishment unit 112 can determine whether both the first device and the second device support the same security protocol. In one example, an indication of security protocols supported by the first device can be transmitted as part of a robust security network (RSN) information element. The first device and the second device may use the RSN information element to negotiate the security protocol that should be implemented. In another implementation, the TDLS link establishment unit 112 can determine whether the first device and the second device are connected to the group owner 102 using the same security protocol (e.g., the WPA2/PSK security protocol). If it is determined that a secure TDLS communication link should be established with the second device, the flow continues at block 218 in FIG. 3. Otherwise, the flow continues at block 210.

At block 210, a TDLS request message is transmitted to the second device. For example, the TDLS link establishment unit 112 of the initiating TDLS-enabled client 106 can transmit the TDLS request message to the TDLS link establishment unit of the destination TDLS-enabled client 114. As part of the TDLS request message, the TDLS link establishment unit 112 can transmit the communication capabilities (e.g., data rates, modulation schemes, etc.) of the initiating TDLS-enabled device 102 and can request the communication capabilities of the destination TDLS-enabled device 114. The flow continues at block 212.

At block 212, a TDLS response message is received from the second device. For example, the TDLS link establishment unit 112 of the initiating TDLS-enabled client 106 can receive the TDLS response message from the TDLS link establishment unit of the destination TDLS-enabled client 114. In one example, the TDLS response message can comprise a status field that indicates whether the second device comprises the same communication capabilities as the first device. For example, the TDLS response message may comprise a first predetermined value indicating a successful TDLS setup (e.g., a value of “00”) if the second device and the first device support the same communication capabilities. The TDLS response message may comprise a second predetermined value indicating an unsuccessful TDLS setup (e.g., a value of “37”) if the second device and the first device do not support the same communication capabilities. As part of the TDLS response message, the TDLS link establishment unit 112 can receive the communication capabilities of the destination TDLS-enabled device 114 and can negotiate communication parameters for subsequent communications. The flow continues at block 214.

At block 214, a TDLS confirmation message is transmitted to the second device. For example, the TDLS link establishment unit 112 of the initiating TDLS-enabled client 106 can transmit the TDLS confirmation message to the TDLS link establishment unit of the destination TDLS-enabled client 114. After the TDLS confirmation message is transmitted to the second device, the TDLS communication link 122 is said to be established between the first device and the second device. The flow continues at block 216.

At block 216, the first device directly communicates with the second device via the TDLS communication link 122. The first device can receive data messages transmitted by the second device via the TDLS communication link 122. The first device can also directly transmit data messages to the second device via the TDLS communication link 122. From block 216, the flow ends.

At block 218 in FIG. 3, a TDLS request message comprising an embedded first session key handshake message is transmitted to the second device. The flow 200 moves from block 208 in FIG. 2 to block 218 in FIG. 3 if the TDLS link establishment unit 112 of the initiating TDLS-enabled client 106 determines that a secure TDLS communication link should be established with the destination TDLS-enabled client 114. The secure TDLS communication link can be established by executing a TDLS peer key (TPK) 3-way handshake procedure. The TPK 3-way handshake procedure can enable the first device and the second device to derive a TPK for secure communication via the TDLS communication link. As described above, with reference to FIG. 1, TPK handshake messages can be embedded with the TDLS handshake messages. In one implementation, the TDLS link establishment unit 112 can append the first TPK handshake message to the TDLS request message and can transmit the two messages to the TDLS link establishment unit of the second device. In another implementation, the TDLS link establishment unit 112 can embed one or more parameters of the first TPK handshake message into the TDLS request message and can transmit the modified TDLS request message to the TDLS link establishment unit of the second device. The TDLS request message can comprise a link identifier, an indication of security protocols supported by the first device, timing information, etc. For example, the embedded first session key handshake message can comprise a link identifier information element, a robust security network (RSN) information element, a timeout interval information element, a fast basic service set (BSS) transition (FT) information element, etc. The flow continues at block 220.

At block 220, a TDLS response message comprising an embedded second session key handshake message is received from the second device. For example, the TDLS link establishment unit 112 can receive the TDLS response message comprising an embedded second TPK handshake message from the TDLS link establishment unit of the second device. As described above, the second TPK handshake message can be appended to the TDLS response message, or one or more parameters of the second TPK handshake message can be inserted as part of the TDLS response message. In some implementations, the embedded second session key handshake message can also comprise a link identifier information element, an RSN information element, a timeout interval information element, a FT information element, etc. The flow continues at block 222.

At block 222, a TDLS confirmation message comprising an embedded third session key handshake message is transmitted to the second device. For example, the TDLS link establishment unit 112 can transmit the TDLS confirmation message comprising an embedded third TPK handshake message to the TDLS link establishment unit of the second device. In some implementations, the embedded second session key handshake message can also comprise a link identifier information element, a RSN information element, a timeout interval information element, a FT information element, etc. The flow continues at block 224.

At block 224, the session key is derived based on the exchanged session key handshake messages. In one example, the TPK can be derived based on the TPK handshake messages exchanged between the first device and the second device at blocks 218-222. After the TDLS confirmation message and the third TPK handshake message is transmitted to the second device, a secure TDLS communication link 122 is said to be established between the first device and the second device. In one example, the TPK can be cached at the first device and at the second device for a predetermined time interval. In another example, the TPK can be cached at the first device and at the second device until the TDLS communication link 122 is broken (or disconnected). The flow continues at block 226.

At block 226, the first device directly communicates with the second device via the secure TDLS communication link 122 using the derived session key. For example, the communication unit 110 can encrypt content to be transmitted to the second device using the TPK. The encrypted content can be transmitted to the second device via the TDLS communication link. Likewise, on receiving encrypted content from the second device, the communication unit 110 can decrypt the received content using the TPK derived at block 224. From block 226, the flow ends.

It should be understood that the depicted diagrams (FIGS. 1-3) are examples meant to aid in understanding embodiments and should not be used to limit embodiments or limit scope of the claims. Embodiments may perform additional operations, fewer operations, operations in a different order, operations in parallel, and some operations differently. For example, although FIGS. 1-3 depict the TDLS-enabled clients 106 and 114 establishing a TDLS communication link 122 for direct data communication, it is noted that the TDLS-enabled clients 106 and 114 may still be connected to the group owner 102 and may also have the ability to communicate via the group owner 102. For example, the TDLS-enabled client 106 can communicate with a client 104 that does not support the TDLS protocol via the group owner 102. As another example, the TDLS-enabled client 106 can communicate with an external network (e.g., an access point of an infrastructure network, a client in another BSS, etc.) via the group owner 102.

Also, although FIG. 1-3 describes the initiating TDLS-enabled client 106 establishing the TDLS communication link 122 with a single destination TDLS-enabled client 114, embodiments are not so limited. In some implementations, the initiating TDLS-enabled client 106 can establish multiple simultaneous TDLS communication links—each with a different destination TDLS-enabled client. For example, a first laptop may establish a first TDLS communication link with a printer and a second laptop may establish a second TDLS communication link with the same printer. Each laptop may directly transmit content to be printed to the printer via their respective TDLS communication link. As another example, a laptop may establish a first TDLS communication link with a printer and a second TDLS communication link with a digital photo frame. The laptop may directly transmit one set of content to be printed to the printer via the first TDLS communication link and may directly transmit another set of content to the digital photo frame via the second TDLS communication link.

In some implementations, each TDLS-enabled client can keep track of other TDLS-enabled clients with which a TDLS communication link was previously established. For example, when the TDLS communication link 122 is established, the initiating TDLS-enabled client 106 can record (e.g., in an internal data structure) that the TDLS communication link 122 was established with the destination TDLS-enabled client 114. Likewise, the destination TDLS-enabled client 114 can record that the TDLS communication link 122 was established with the initiating TDLS-enabled client 106. After the client devices complete the scheduled communication(s), the TDLS communication link 122 can be broken (by either the destination TDLS-enabled client 114 or the initiating TDLS-enabled client 106) by transmitting a TDLS tear-down request. At a later time, the initiating TDLS-enabled client 106 may determine to communicate with and to establish a TDLS communication link with the destination TDLS-enabled client 114 again. To communicate with the destination TDLS-enabled client 114 with which the TDLS communication link 122 was previously established, the initiating TDLS-enabled client 106 and the destination TDLS-enabled client 114 may automatically establish the new TDLS communication link without executing the 3-way handshaking and authentication operations for setting up another TDLS communication link when the initiating TDLS-enabled client 106 initiates data transfer to the destination TDLS-enabled client 114. In other words, when attempting to reconnect to the destination TDLS-enabled client 114, the initiating TDLS-enabled client 106 can check the internal data structure and can determine that the initiating TDLS-enabled client 106 had previously established a TDLS communication link with the destination TDLS-enabled client 114. Therefore, the initiating TDLS-enabled client 106 can automatically establish a new TDLS communication link with the destination TDLS-enabled client 114 without executing the 3-way handshaking and authentication operations for setting up the new TDLS communication link.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). A machine-readable medium may be a non-transitory machine-readable storage medium, or a transitory machine-readable signal medium. A machine-readable storage medium may include, for example, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of tangible medium suitable for storing electronic instructions. A machine-readable signal medium may include a propagated data signal with computer readable program code embodied therein, for example, an electrical, optical, acoustical, or other form of propagated signal (e.g., carrier waves, infrared signals, digital signals, etc.). Program code embodied on a machine-readable medium may be transmitted using any suitable medium, including, but not limited to, wireline, wireless, optical fiber cable, RF, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

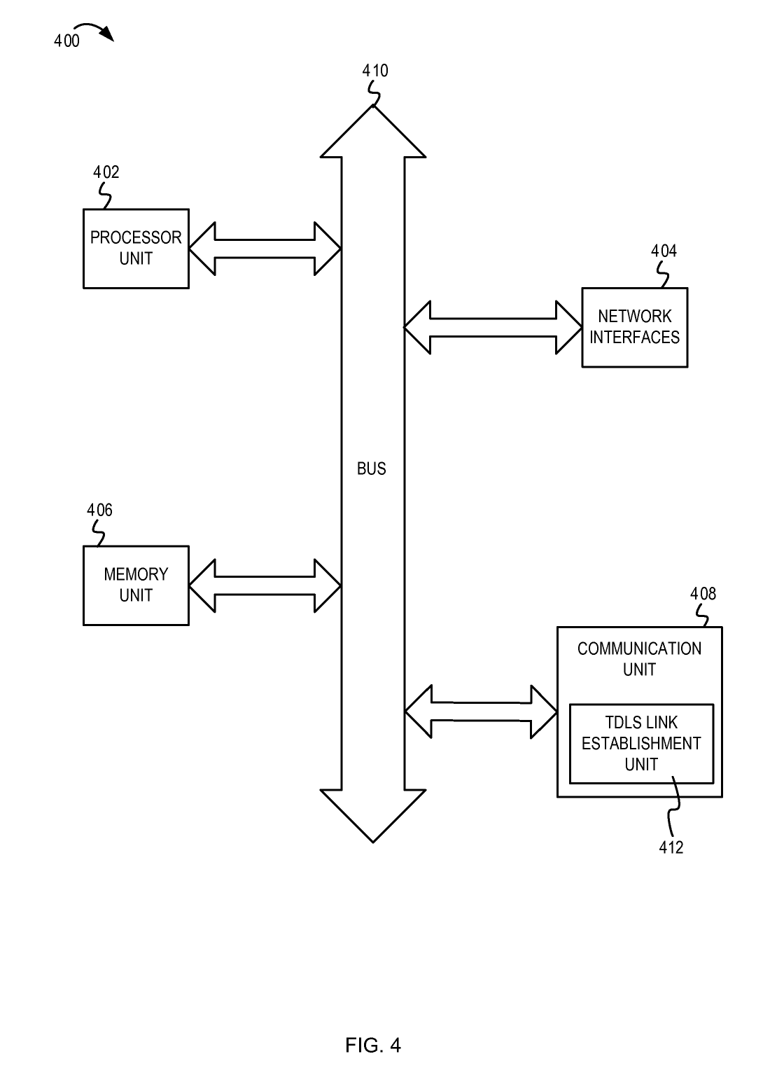

FIG. 4 is a block diagram of one embodiment of an electronic device 400 including a mechanism for direct data communication in a peer-to-peer network. In some implementations, the electronic device 400 may be a laptop, a personal computer (PC), a netbook, a mobile phone, a personal digital assistant (PDA), a printer, or other suitable electronic system, which can connect to and exchange data in a peer-to-peer network. The electronic device 400 includes a processor unit 402 (possibly including multiple processors, multiple cores, multiple nodes, and/or implementing multi-threading, etc.). The electronic device 400 includes a memory unit 406. The memory unit 406 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 400 also includes a bus 410 (e.g., PCI, ISA, PCI-Express, HyperTransport®, InfiniBand®, NuBus, AHB, AXI, etc.), and network interfaces 404 that include at least one of a wireless network interface (e.g., a WLAN interface, a Bluetooth® interface, a WiMAX interface, a ZigBee® interface, a Wireless USB interface, etc.) and a wired network interface (e.g., an Ethernet interface).

The electronic device 400 also includes a communication unit 408. The communication unit 408 comprises a TDLS link establishment unit 412 that enables a TDLS communication link to be established with a second electronic device in the peer-to-peer network. The communication unit 408 can determine whether the second electronic device supports the TDLS protocol and whether the second electronic device supports the same communication capabilities as the electronic device 400. The communication unit 408 can establish either a secure or a non-secure TDLS communication link with the second electronic device to enable direct data communication with the second electronic device, as described above with reference to FIGS. 1-3. Any one of these functionalities may be partially (or entirely) implemented in hardware and/or on the processor unit 402. For example, the functionality may be implemented with an application specific integrated circuit, in logic implemented in the processor unit 402, in a co-processor on a peripheral device or card, etc. Further, realizations may include fewer or additional components not illustrated in FIG. 4 (e.g., video cards, audio cards, additional network interfaces, peripheral devices, etc.). The processor unit 402, the memory unit 406, and the network interfaces 406 are coupled to the bus 410. Although illustrated as being coupled to the bus 410, the memory unit 406 may be coupled to the processor unit 402.

While the embodiments are described with reference to various implementations and exploitations, it will be understood that these embodiments are illustrative and that the scope of the inventive subject matter is not limited to them. In general, techniques for direct data communication in a peer-to-peer network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining, at a first network device of a peer-to-peer communication network, to communicate with a second network device of the peer-to-peer communication network;
determining, at the first network device, whether the second network device supports a direct data communication protocol supported at the first network device based on an indication received from a managing network device of the peer-to-peer communication network;
in response to determining that the second network device supports the direct data communication protocol,
exchanging a set of handshake messages associated with the direct data communication protocol with the second network device to establish a direct data communication link between the first network device and the second network device; and
transmitting, from the first network device, subsequent data messages to the second network device via the direct data communication link.

2. The method of claim 1, wherein said determining whether the second network device supports the direct data communication protocol supported at the first network device comprises:
receiving, at the first network device from the managing network device of the peer-to-peer communication network, a beacon message that indicates communication capabilities of a plurality of network devices of the peer-to-peer communication network, wherein the plurality of network devices comprise the first network device and the second network device; and
determining that the second network device supports the direct data communication protocol supported at the first network device in response to said receiving the beacon message from the managing network device of the peer-to-peer communication network.

3. The method of claim 2, wherein said determining whether the second network device supports the direct data communication protocol supported at the first network device further comprises:
reading, from the beacon message, a direct data communication bit associated with the second network device; and
determining that the direct data communication bit comprises a predetermined value that indicates that the second network device supports the direct data communication protocol.

4. The method of claim 1, further comprising:
in response to determining that the second network device supports the direct data communication protocol, determining whether to establish a secure direct data communication link with the second network device based, at least in part, on security protocols supported at the first network device and the second network device.

5. The method of claim 4, wherein said exchanging the set of handshake messages associated with the direct data communication protocol with the second network device comprises:
in response to determining not to establish the secure direct data communication link with the second network device,
transmitting, from the first network device, a direct data communication request message to the second network device;
receiving, at the first network device, a direct data communication response message from the second network device;
transmitting, from the first network device, a direct data communication confirmation message to the second network device; and
establishing the direct data communication link with the second network device, wherein the established direct data communication link is not a secure communication link.

6. The method of claim 4, wherein said exchanging the set of handshake messages associated with the direct data communication protocol with the second network device comprises:
in response to determining to establish the secure direct data communication link with the second network device,
transmitting, from the first network device, a direct data communication request message comprising an embedded first session key handshake message to the second network device;
receiving, at the first network device, a direct data communication response message comprising an embedded second session key handshake message from the second network device;
transmitting, from the first network device, a direct data communication confirmation message comprising an embedded third session key handshake message to the second network device; and
establishing the secure direct data communication link with the second network device.

7. The method of claim 6, further comprising:
deriving a session key for subsequent communication with the second network device via the secure direct data communication link based on exchanging the first session key handshake message, the second session key handshake message, and the third session key handshake message.

8. The method of claim 7, wherein said transmitting, from the first network device, the subsequent data messages to the second network device via the direct data communication link comprises:
encrypting the subsequent data messages using the derived session key; and
transmitting, to the second network device via direct data communication link, the data messages that were encrypted using the derived session key.

9. The method of claim 1, wherein the direct data communication protocol is a tunneled direct link setup (TDLS) protocol.

10. The method of claim 1, wherein in response to determining that the second network device does not support the direct data communication protocol, the method further comprises
communicating with the second network device via the managing network device of the peer-to-peer communication network.

11. A network device comprising:
a processor;
a network interface coupled to the processor;
a direct data communication unit coupled to the network interface and to the processor, the direct data communication unit operable to:
determine to communicate with a destination network device of a peer-to-peer communication network;
determine whether the destination network device supports a direct data communication protocol supported at the network device based on an indication received from a managing network device of the peer-to-peer communication network;
in response to determining that the destination network device supports the direct data communication protocol,
exchange a set of handshake messages associated with the direct data communication protocol with the destination network device to establish a direct data communication link between the network device and the destination network device; and
transmit subsequent data messages to the destination network device via the direct data communication link.

12. The network device of claim 11, wherein the direct data communication unit operable to determine whether the destination network device supports the direct data communication protocol supported at the network device comprises the direct data communication unit operable to:
receive, from the managing network device of the peer-to-peer communication network, a beacon message that indicates communication capabilities of a plurality of network devices of the peer-to-peer communication network, wherein the plurality of network devices comprise the network device and the destination network device; and
determine that the destination network device supports the direct data communication protocol supported at the network device in response to the direct data communication unit receiving the beacon message from the managing network device of the peer-to-peer communication network.

13. The network device of claim 12, wherein the direct data communication unit operable to determine whether the destination network device supports the direct data communication protocol supported at the network device further comprises the direct data communication unit operable to:
read, from the beacon message, a direct data communication bit associated with the destination network device; and
determine that the direct data communication bit comprises a predetermined value that indicates that the destination network device supports the direct data communication protocol.

14. The network device of claim 11, wherein the direct data communication unit is further operable to:
in response to the direct data communication unit determining that the destination network device supports the direct data communication protocol, determine whether to establish a secure direct data communication link with the destination network device based, at least in part, on security protocols supported at the network device and the destination network device.

15. The network device of claim 14, wherein the direct data communication unit operable to exchange the set of handshake messages associated with the direct data communication protocol with the destination network device comprises the direct data communication unit operable to:
in response to determining not to establish the secure direct data communication link with the destination network device,
transmit a direct data communication request message to the destination network device;
receive a direct data communication response message from the destination network device;
transmit a direct data communication confirmation message to the destination network device; and
establish the direct data communication link with the destination network device, wherein the established direct data communication link is not a secure communication link.

16. The network device of claim 14, wherein the direct data communication unit operable to exchange the set of handshake messages associated with the direct data communication protocol with the destination network device comprises the direct data communication unit operable to:
in response to determining to establish the secure direct data communication link with the destination network device,
transmit a direct data communication request message comprising an embedded first session key handshake message to the destination network device;
receive a direct data communication response message comprising an embedded second session key handshake message from the destination network device;
transmit a direct data communication confirmation message comprising an embedded third session key handshake message to the destination network device; and
establish the secure direct data communication link with the destination network device.

17. The network device of claim 16, wherein the direct data communication unit is further operable to:
derive a session key for subsequent communication with the destination network device via the secure direct data communication link based on the direct data communication unit exchanging the first session key handshake message, the second session key handshake message, and the third session key handshake message.

18. The network device of claim 17, wherein the direct data communication unit operable to transmit the subsequent data messages to the destination network device via the direct data communication link comprises the direct data communication unit operable to:
encrypt the subsequent data messages using the derived session key; and
transmit, to the destination network device via direct data communication link, the data messages that were encrypted using the derived session key.

19. The network device of claim 11, wherein in response to the direct data communication unit determining that the second network device does not support the direct data communication protocol, the direct data communication unit is further operable to:
communicating with the destination network device via the managing network device of the peer-to-peer communication network.

20. One or more machine-readable storage media, having instructions stored therein, which, when executed by one or more processors causes the one or more processors to perform operations that comprise:
determining, at a first network device of a peer-to-peer communication network, to communicate with a second network device of the peer-to-peer communication network;
determining, at the first network device, whether the second network device supports a direct data communication protocol supported at the first network device based on an indication received from a managing network device of the peer-to-peer communication network;
in response to determining that the second network device supports the direct data communication protocol,
exchanging a set of handshake messages associated with the direct data communication protocol with the second network device to establish a direct data communication link between the first network device and the second network device; and
transmitting subsequent data messages to the second network device via the direct data communication link.

21. The one or more machine-readable storage media of claim 20, wherein said operation of determining whether the second network device supports the direct data communication protocol supported at the first network device comprises:
receiving, from the managing network device of the peer-to-peer communication network, a beacon message that indicates communication capabilities of a plurality of network devices of the peer-to-peer communication network, wherein the plurality of network devices comprise the first network device and the second network device;
reading, from the beacon message, a direct data communication bit associated with the second network device;
determining that the direct data communication bit comprises a predetermined value that indicates that the second network device supports the direct data communication protocol; and
determining that the second network device supports the direct data communication protocol supported at the first network device in response to determining that the direct data communication bit comprises the predetermined value that indicates that the second network device supports the direct data communication protocol.

22. The one or more machine-readable storage media of claim 20, wherein said operation of exchanging the set of handshake messages associated with the direct data communication protocol with the second network device comprises:
in response to determining that the destination network device supports the direct data communication protocol, determining whether to establish a secure direct data communication link with the second network device based, at least in part, on security protocols supported at the first network device and the second network device;
in response to determining not to establish the secure direct data communication link with the second network device,
transmitting a direct data communication request message to the second network device;
receiving a direct data communication response message from the second network device;
transmitting a direct data communication confirmation message to the second network device; and
establishing the direct data communication link with the second network device, wherein the established direct data communication link is not a secure communication link.

23. The one or more machine-readable storage media of claim 20, wherein said operation of exchanging the set of handshake messages associated with the direct data communication protocol with the second network device comprises:
in response to determining that the destination network device supports the direct data communication protocol, determining whether to establish a secure direct data communication link with the second network device based, at least in part, on security protocols supported at the first network device and the second network device;
in response to determining to establish the secure direct data communication link with the second network device,
transmitting a direct data communication request message comprising an embedded first session key handshake message to the second network device;
receiving a direct data communication response message comprising an embedded second session key handshake message from the second network device;
transmitting a direct data communication confirmation message comprising an embedded third session key handshake message to the second network device; and
establishing the secure direct data communication link with the second network device.

24. The one or more machine-readable storage media of claim 23, wherein the operations further comprise:
deriving a session key for subsequent communication with the second network device via the secure direct data communication link based on exchanging the first session key handshake message, the second session key handshake message, and the third session key handshake message;
encrypting the subsequent data messages using the derived session key; and
transmitting, to the second network device via direct data communication link, the data messages that were encrypted using the derived session key.
